(19) United States
(12) Patent Application Publication
(10) Pub. No.: US 2009/0171574 A1
(43) Pub. Date: Jul. 2, 2009

(54) NAVIGATION SYSTEM, NAVIGATION EQUIPMENT AND DESTINATION SETTING METHOD

(75) Inventors: Isao Ishibashi, Kobe-shi (JP); Teru Sawada, Kobe-shi (JP); Shigeru Yamakoshi, Tokyo (JP); Yuuichi Tada, Tokyo (JP)

Correspondence Address: OLIFF & BERRIDGE, PLC, P.O. BOX 320850, ALEXANDRIA, VA, 22320-4850, US

(73) Assignee: FUJITSU TEN LIMITED, KOBE-SHI (JP)

(21) Appl. No.: 12/318,335

(22) Filed: Dec. 24, 2008

(30) Foreign Application Priority Data
Dec. 28, 2007 (JP) 2007-338822

(51) Int. Cl. G01C 21/00

(52) U.S. Cl. 701/209

(57) ABSTRACT

A navigation system sets a destination of navigation equipment by forwarding spot information managed by a server to the navigation equipment via a mobile terminal. The server includes write information accepting unit accepting write information from a plurality of users via a network, spot information generating unit generating the spot information based on the write information, spot information storage unit stored with the generated spot information, extracting unit extracting predetermined spot information in response to a search request, and transmitting unit transmitting the spot information to the mobile terminal. The mobile terminal includes receiving unit receiving the predetermined spot information, terminal display unit displaying the predetermined spot information, and forwarding unit forwarding the predetermined spot information to the navigation equipment. The navigation equipment includes navigation control unit setting the destination from the predetermined spot information.

### CROSS-REFERENCE TO RELATED APPLICATIONS

This application is based upon and claims the benefit of priority of the prior Japanese Patent Application No. 2007-338822, filed on Dec. 28, 2007, the entire contents which are incorporated herein by reference.

### BACKGROUND

The present invention relates to a navigation system, navigation equipment and a destination setting method.

Conventional navigation equipment mounted in a vehicle has a problem that setting a destination entails directly inputting pieces of information such as an address, a name and a telephone number from an operation unit, and its convenience does not reach an acceptable level. A technology known as a technology for solving this type of problem is disclosed in, e.g., Patent document 1. Patent document 1 discloses the technology of previously storing spot information containing position information in a server, searching for the spot information etc containing the position information in response to an information search request given from a mobile terminal connected via a network to the server, transmitting the position information contained in a search result to navigation equipment through infrared-ray communications, and thus setting a destination of the navigation equipment.

[Patent document 1] Japanese Patent Laid-Open Publication No. 2002-22468

### SUMMARY

Disclosed is a technology by which the mobile terminal searches for the spot information containing the position information stored in the server, the position information contained in the search result is transmitted to the navigation equipment through the infrared-ray communications, and the destination of the navigation equipment is set. This technology enables the navigation equipment to perform a route guidance by utilizing the position information searched via the mobile terminal. Thus, in the case of setting the destination of the navigation equipment from the information stored in the server, if the server is stored with a small quantity of information or old pieces of information, the information satisfying a desire of a user can not be obtained, and consequently there might be a case in which the user can not be guided to the destination conforming to the user's desire. In other words, if capable of searching for predetermined information based on a much greater quantity of information and even newer information and setting the position information contained in the search result as the destination of the navigation equipment, the user can be guided to the destination conforming to the user's desire.

It is an object of the present invention, which was devised in view of the problems described above, to provide a technology capable of guiding a user to a destination that is as close as the user desires.

### MEANS FOR SOLVING THE PROBLEMS

According to the present invention, for solving the problems described above, a destination of navigation equipment is set based on spot information generated based on write information given from a plurality of users.

Specifically, a navigation system according to the present invention sets a destination of navigation equipment by forwarding spot information containing at least position information managed by a server to the navigation equipment via a mobile terminal, the server comprising: write information accepting unit that accepts write information from a plurality of users via a network; spot information generating unit that generates the spot information based on the write information accepted by the write information accepting unit; storage unit that stores with the spot information generated by the spot information generating unit; extracting unit that extracts, from the spot information stored in the storage unit, predetermined spot information corresponding to candidates of the destination in response to a search request given from the mobile terminal; and transmitting unit that transmits the predetermined spot information extracted by the extracting unit to the mobile terminal, the mobile terminal comprising: receiving unit that receives the predetermined spot information transmitted by the transmitting unit; terminal display unit that displays the predetermined spot information received by the receiving unit; and forwarding unit that forwards the predetermined spot information displayed by the terminal display unit to the navigation equipment, the navigation equipment comprising: accepting unit that accepts the predetermined spot information forwarded from the mobile terminal; destination setting unit that sets the destination based on the position information contained in the predetermined spot information accepted by the accepting unit; and navigation display unit that displays a route to the destination set by the destination setting unit.

According to the present invention, the destination of the navigation equipment can be set based on the spot information generated based on the write information given from the plurality of users, i.e., the spot information in which an extremely large quantity of new information reflects. As a result, according to the present invention, the user can be guided to the destination that is as close as the user's desire.

The server comprises the write information accepting unit, the spot information generating unit, the storage unit, the extracting unit and the transmitting unit. The write information accepting unit accepts the write information from the plurality of users via the network. The write information contains various items of information organizing the spot information. The write information may be a comment, a photo, etc in addition to the position information for specifying the position. The write information may also be information that is newly added to the spot information itself in addition to the information for supplementing and modifying the spot information already managed by the server. The write information is exemplified by texts such as comments and news, the photo, moving pictures and voices, and is acquired via the network connected to the server. The network is a network for establishing connections between the server, the mobile terminal, a personal computer, etc., and is a communication network such as a mobile communication network and the Internet. The spot information is sufficient if capable of creating a map by including the position information of a specified spot, and is generated based on the write information. The spot information is exemplified by information about restaurants, information on popular spots and information on a variety of spots based on interests of the users. The position information may be information for specifying the position and is exemplified by longitude/latitude information and pieces of information about a post code, an address, a telephone number, etc.

The extracting unit extracts the predetermined spot information corresponding to the candidates of the destination in response to the search request given from the mobile terminal from within the spot information stored in the storage unit. The search request represents conditions inputted by the user from on the mobile terminal and is exemplified by keywords inputted by the mobile terminal and favorite items described in a top page selected by the mobile terminal. Note that the search request may also be a request based on a tag and an access count, which are set by the user.

The transmitting unit transmits the predetermined spot information extracted by the extracting unit to the mobile terminal via the network. In the mobile terminal, the receiving unit receives the predetermined spot information transmitted therefrom, and the terminal display unit displays the received spot information. The predetermined spot information is information extracted in response to the search request from within many pieces of spot information stored in the storage unit and may take either a singular form or a plural form. The forwarding unit forwards the predetermined spot information displayed on the terminal display unit to the navigation equipment. Note that if the predetermined spot information displayed on the terminal display unit takes the plural form, it is acceptable for the user to select the plural pieces of predetermined spot information, and only the predetermined spot information selected by the user may also be forwarded to the navigation equipment. Accordingly, in this case, selection accepting unit for accepting the selection from the user may be separately provided on the mobile terminal.

The predetermined spot information forwarded from the mobile terminal is accepted by the accepting unit of the navigation equipment. The forwarding process from the mobile terminal can be done through, e.g., the infrared-ray communications. The forwarding process is not, however, limited to the infrared-ray communications. An electrical connection may be sufficient, and both of a wireless connection and a wired connection are usable. The destination setting unit sets the destination based on the spot information accepted by the accepting unit. Namely, the destination setting unit sets the destination to which the user is route-guided based on the information (e.g., longitude/latitude information) about a location contained in the spot information. It should be noted that what is sufficient as the mobile terminal is a terminal including the receiving unit, the terminal display unit and the forwarding unit, and a mode thereof is not particularly limited. The mobile terminal excluding desktop type terminals is exemplified such as a handy type terminal and a notebook type terminal.

Note that the accepting unit of the navigation equipment may accept plural pieces of predetermined spot information through one forwarding operation from the forwarding unit. In this case, the navigation equipment may further comprise; present position information acquiring unit that acquires present position information about the present position of the navigation equipment; and sequencing unit that compares the present position information acquired by the present position information acquiring unit with the position information contained in the plural pieces of predetermined spot information accepted by the accepting unit, and sequencing the plural pieces of predetermined spot information on the basis of predetermined conditions containing at least a distance from the present position to the destination and a period of time required from the present position to the destination, and the destination setting unit can set the destination on the basis of the position information contained in the plural pieces of predetermined spot information sequenced by the sequencing unit.

The present position information acquiring unit acquires the present position information of the navigation equipment mounted with the navigation control device according to the present invention. The acquisition of the present position may involve utilizing a GPS (Global Positioning System) provided in the conventional navigation equipment.

The sequencing unit sequences the plural pieces of predetermined spot information transmitted from the mobile terminal. More specifically, the sequencing unit compares the present position information acquired by the present position information acquiring unit with the position information contained in the plural pieces of predetermined spot information accepted by the accepting unit, and sequences the plural pieces of predetermined spot information on the basis of predetermined conditions containing at least any one of a distance from the present position to the destination and a period of time required from the present position to the destination. The distance from the present position to the destination and the time required from the present position to the destination can be calculated by properly using a technology of the conventional navigation equipment. Note that the distance and the time required from the present position to one destination are different depending on the guidance route. Namely, the distance and the time required from the present position to the destination are different depending on the search conditions (e.g., whether a superhighway is used or not, and so on). Accordingly, in the case of calculating the guidance route per destination and further calculating a plurality of guidance routes, for example, after unifying the search conditions such as whether the superhighway is used or not, the optimal guidance route is selected each time, and it is preferable to compare the distance and the required time along the selected optimal guidance route. This scheme enables the more accurate comparison and sequencing process to be attained.

In the case of executing the sequencing process, the destination setting unit sets the destination based on the plural pieces of predetermined spot information sequenced by the sequencing unit. For example, in the case of sequencing the position information based on the distance from the present position to the destination and sequencing the position information in the order from the shortest distance, it follows that the destination having the shortest distance from the present position to the destination is set as a first destination.

Herein, according to the present invention, the navigation display unit may display the spot information accepted by the accepting unit in addition to the route to the destination set by the destination setting unit. Each of the navigation display unit and the terminal display unit can be constructed of a display, however, generally the navigation display unit can display a greater quantity of information than by the terminal display unit. Accordingly, the plural pieces of predetermined spot information are displayed on the navigation display unit and can thereby be displayed in an easier-to-see mode.

Herein, the present invention may further comprise traffic jam information acquiring unit that acquires traffic jam information, and traffic jam information storage unit stored with the traffic jam information acquired by the traffic jam information acquiring unit, and the sequencing unit may sequence the plural pieces of predetermined spot information in a way that takes account of real-time traffic jam information acquired by the traffic jam information acquiring unit and the traffic jam information stored in the traffic jam information storage unit.

The traffic jam information acquiring unit acquires the traffic jam information. The acquisition of the traffic jam information may involve utilizing VCS (Vehicle Information and Communication System) incorporated into the conventional navigation equipment. On the occasion of the sequencing the position information, the more proper sequencing process can be conducted in a way that takes the traffic jam information into consideration. Herein, for example, in the case of obtaining the traffic jam information by utilizing the VICS, the real-time traffic jam information has an error occurring between the actual crowded state and the obtained traffic jam information such as occurrence of a time lag. This being the case, a scheme of the present invention is that not only the real-time traffic jam information but also the traffic jam information in the past are taken into consideration. The traffic jam information storage unit is stored with the traffic jam information acquired by the traffic jam information acquiring unit. For instance, the traffic jam information storage unit is stored with the traffic jam information in a way that sorts out the crowded state per guidance route into days of the week and time zones. The crowded state may be stored stepwise such as “crowded” and “smooth”. On the occasion of sequencing the position information, the more proper sequencing process can be attained by taking account of the past traffic Jam information stored in the traffic jam information storage unit.

Further, according to the present invention, the receiving unit of the mobile terminal may receive the plural pieces of predetermined spot information, the mobile terminal may further comprise rearranging unit that rearranges the plural pieces of predetermined spot information under predetermined conditions, the forwarding unit of the mobile terminal may forward the plural pieces of predetermined spot information rearranged by the rearranging unit to the navigation equipment, the accepting unit of the navigation equipment may accept the plural pieces of rearranged predetermined spot information forwarded from the mobile terminal, and the destination setting unit may set the destination based on the position information contained in the plural pieces of rearranged predetermined spot information accepted by the accepting unit.

The predetermined condition is exemplified by popular ranking. Further, when the mobile terminal has the GPS function, the present position information acquired by the present position information acquiring unit of the mobile terminal is compared with the position information contained in the plural pieces of predetermined spot information received by the receiving unit of the mobile terminal, and the plural pieces of position information can be sequenced based on the predetermined conditions containing at least any one of the distance from the present position to the destination and the time required from the present position to the destination.

Herein, the present invention may be configured as a server, navigation equipment and a mobile terminal, which build up the navigation system described above, Further, the present invention may also be configured as a method (a destination setting method) or a program for realizing processes executed by the navigation control device, the server and the mobile terminal. Still further, the present invention may also be configured as a readable-by-computer recording medium recorded with such a program. In this case, the program on the recording medium can be read and executed by a computer etc, thereby enabling a function thereof to be provided. It is to be noted that the recording medium, which can be read by the computer etc connotes a recording medium capable of storing information such as data, programs, etc. electrically, magnetically, optically, mechanically or by chemical action, which can be read from the computer and so on. According to the present invention, it is feasible to provide the technology capable of guiding the user to the destination that is as close as the user's desire.

### BRIEF DESCRIPTION OF DRAWINGS

FIG. 1 is a diagram showing an outline of an architecture of a navigation system in a first embodiment.

FIG. 2 is a function block diagram of a server.

FIG. 3 is a diagram showing an outline of structure of spot information stored in a storage unit.

FIG. 4 is a diagram showing one example of a database in which the spot information is organized.

FIG. 5 is a diagram showing one example of a search screen displayed on a display unit of a mobile terminal.

FIG. 6 is a function block diagram of the mobile terminal.

FIG. 7 is a diagram showing one example of a display status of the spot information transmitted to the mobile terminal from the server.

FIG. 8 is a diagram showing an outline of a configuration of navigation equipment.

FIG. 9 is a function block diagram of a navigation control unit.

FIG. 10 is a flowchart showing a processing flow executed by the navigation system in the first embodiment.

FIG. 11 is a function block diagram of the navigation control unit in a second embodiment.

FIG. 12 is a diagram showing one example of a database of traffic jam information.

FIG. 13 is a flowchart showing a flow of a destination setting process executed in the navigation system in the second embodiment.

FIG. 14 is a sequence diagram in the case of forwarding plural pieces of spot information at one time.

FIG. 15 is a diagram showing a display status of the navigation equipment.

FIG. 16 is a function block diagram of a control unit of a mobile terminal in a third embodiment.

### DESCRIPTION OF EMBODIMENTS

Embodiments of a navigation system according to the present invention will be described.

### First Embodiment

### Architecture

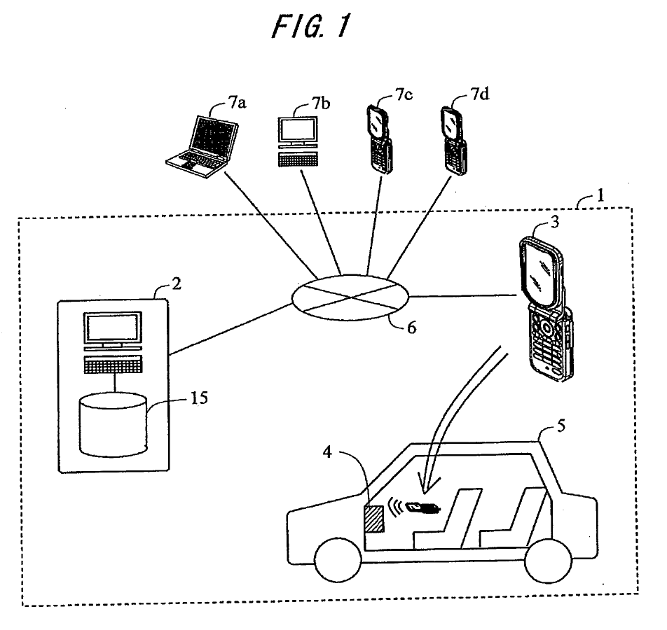

FIG. 1 illustrates an outline of an architecture of a navigation system according to a first embodiment. As illustrated in FIG. 1. A navigation system 1 in the first embodiment is configured by a server 2, a mobile terminal 3 and navigation equipment 4 mounted in a vehicle 5. Then, the server 2 is connected to the mobile terminal 3 via a communication network 6, and further a multiplicity of personal computers 7a, 7b and a multiplicity of external mobile terminals 7c, 7d are accessible to the server 2 via the communication network 6. Note that the communication network 6 is a network via which the server 2 connects with the mobile terminal 3 and the external personal computers 7a, 7b, and can be built up by a communication network such as a mobile communication network and the Internet.

(Server)

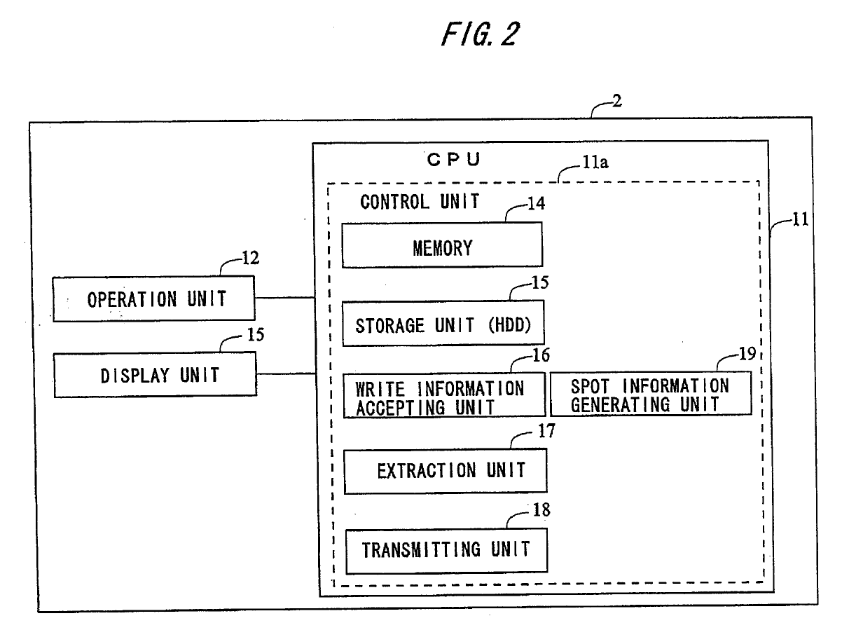

FIG. 2 shows a function block diagram of the server 2. The server 2 is constructed of a CPU (Central Processing Unit) 11, a control unit 11a, an operation unit 12 and a display unit 13. The control unit 11a is constructed of a memory 14, a storage unit (hard disk drive) 15, a write information accepting unit 16, an extraction unit 17, a transmitting unit 18 which transmits an extracted piece of predetermined spot information, and a spot information generating unit 19. Note that the write information accepting unit 16, the extraction unit 17, the transmitting unit 18 and the spot information generating unit 19 can be configured as computer programs running on a CPU 21.

The CPU 11, which is connected to respective hardware components such as the storage unit 15 via a bus, controls the hardware such as the storage unit 15 and executes predetermined processes according to a control program stored in, e.g., a ROM serving as the memory 14.

The storage unit 15 can be constructed of the hard disk drive. The memory 14 includes a volatile RAM (Random Access Memory) and a nonvolatile ROM (Read Only Memory). The ROM includes writable semiconductor memories such as a flash memory, an EPROM (Erasable Programmable Read-Only Memory) and an EEPROM (Electrically Erasable Programmable Read-only Memory).

The operation unit 12 includes an input device such as a keyboard and a pointing device of a computer. The display unit 13 is exemplified by, e.g., a liquid crystal display device, a plasma display panel, a CRT (Cathode Ray Tube), an electroluminescence panel, etc.

The write information accepting unit 16 accepts pieces of write information from a plurality of users via a network, To be specific, the write information accepting unit 16 accepts the write information from the multiplicity of personal computers 7a, 7b and external mobile terminals 7c, 7d via the communication network 6. The write information contains, in addition to position information for specifying positions, comments, photos, etc. The write information may also be information for supplementing and modifying the spot information already managed by the server 2 and, in addition, information which is newly added to the spot information itself.

The spot information generating unit 19 generates the spot information based on the write information accepted by the write information accepting unit 16. The write information contains texts such as comments and news, photos, moving pictures, voices, etc. The spot information contains Exif (Exchangeable Image File format) information and news information. The Exif information is generated in a way that forwards the position information contained in image data to the navigation equipment when seeing an image (e.g., a scene) acquired by, e.g., a search for images and wanting to go to this spot. Further, the news information is generated by forwarding the news information with the position information being allocated to the news itself to the navigation equipment. The position information may be sufficient if being information enabling the position to be specified and may also be, without being limited to a longitude and a latitude, a post code, an address, a telephone number, etc.

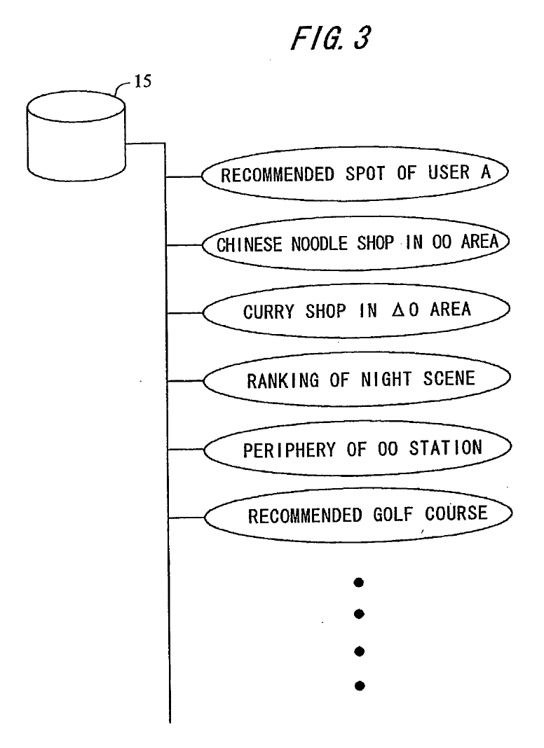

The storage unit 15 corresponds to spot information storing unit according to the present invention, and is stored with the generated spot information. Herein, FIG. 3 shows an outline of a structure of the spot information stored in the storage unit 15. As shown in FIG. 3, the spot information stored in the storage unit 15 is organized by a plurality of databases corresponding to themes created by the user. For example, The plural categories of databases are a recommended spot of a user A, a Chinese noodle shop in a OO area, a curry shop in a ΔO area, night scene ranking, a periphery of the OO station and a recommended golf course. These categories of databases are generated in such a way that the user inputs a new piece of information and the write information (the longitude/latitude, a name of the spot, the address, etc) conforming to the theme via the external personal computers 7a, 7b and the external mobile terminals 7c, 7d.

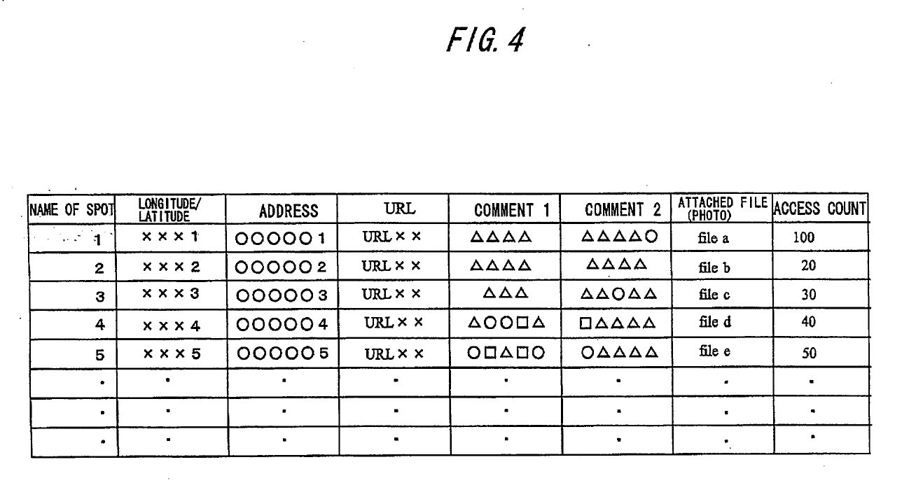

FIG. 4 shows one example of the database in which the spot information stored in the storage unit 15 is organized. The database shown in FIG. 4 corresponds to the recommended spot of the user A and consists of fields such as the name of the spot, the longitude/latitude, the address, URL, the comments, the photo and an access count from the user. The comments are the comments written by other users as the write information via the external personal computers 7a, 7b and the external mobile terminals 7c, 7d. The database, in which the spot information stored in the thus-structured storage unit 15 is organized, is generated and updated at any time with the write information given from the plurality of users.

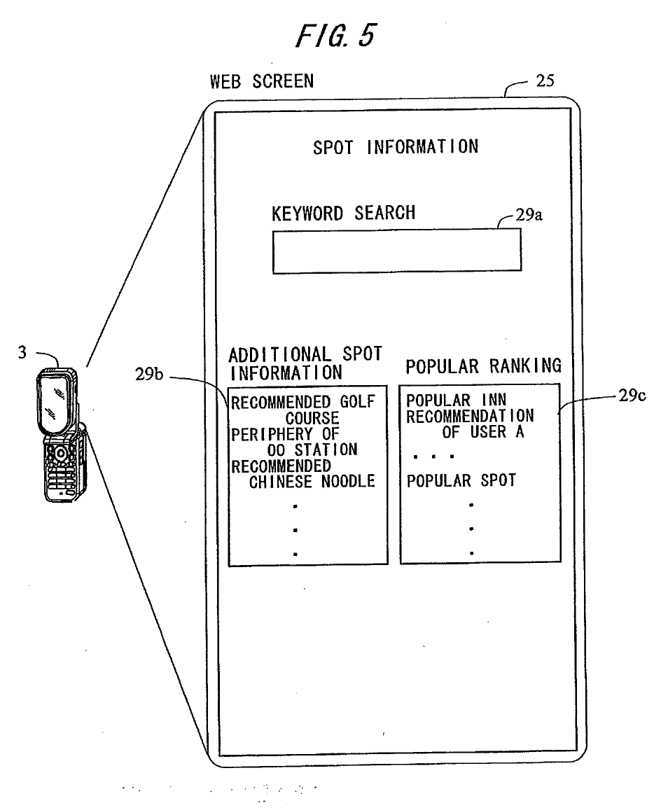

The extraction unit 17 extracts the predetermined spot information from the pieces of spot information stored in the storage unit 15 on the basis of search conditions inputted from the mobile terminal 3. The search conditions are exemplified by, e.g., keyword-based conditions. Herein, FIG. 5 shows one example of a search screen displayed on a display unit 25 of the mobile terminal 3. A Web page is displayed on the display unit 25 of the mobile terminal 3, and a keyword input box 29a, additional spot information 29b and popular ranking 29c are displayed on the Web page. For example, when a recommended spot is inputted to the keyword input box 29a, the extraction unit 17 extracts the spot information stored in the database named [recommended spot of user A] from the storage unit 15 (see FIGS. 3 and 4). Note that the search conditions are not limited to the keywords. The additional spot information 29b and the popular ranking 29c are previously displayed on the display unit 25 of the mobile terminal 3. Accordingly, any one of items displayed on the display unit may be directly selected without making the keyword-based search. In this case, it follows that the extraction unit 17 extracts the spot information associated with the selected item. Incidentally, the additional spot information 29b is information that is newly added as recently as within, e.g., 24 hours. The popular ranking 290 is information based on the access count.

The transmitting unit 18 transmits the extracted spot information to the mobile terminal 3 via the communication network 6. A description format on the occasion of transmitting the spot information is not particularly limited but can be set to, e.g., an HTML (HyperText Markup Language) format. The spot information contains at least the longitude/latitude as the position information.

(Mobile Terminal)

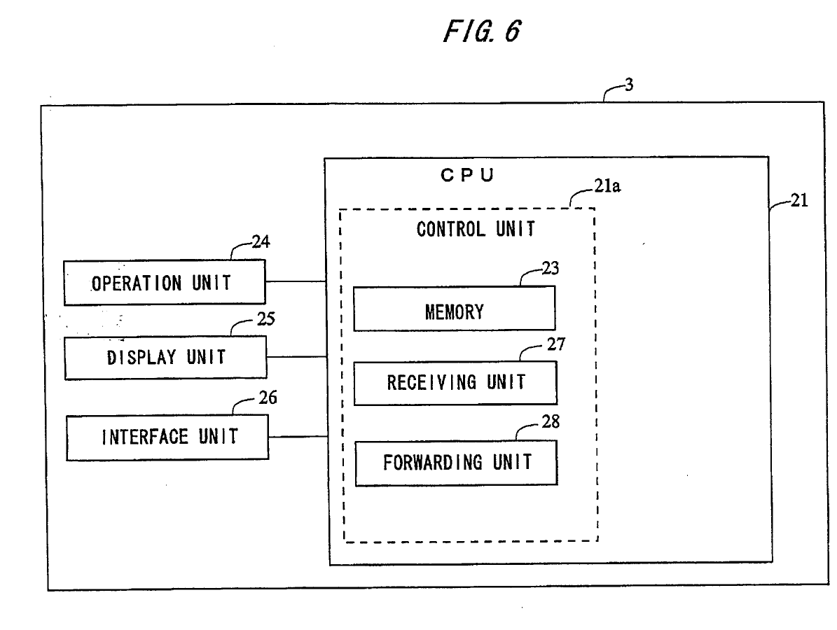

FIG. 6 shows a function block diagram of the mobile terminal 3. As illustrated in FIG. 6, the mobile terminal 3 is constructed of a CPU (Central Processing Unit) 21, a control unit 21a, an operation unit 24, the display unit 25 and an interface unit 26 connectable to the external device. The control unit 21a of the mobile terminal 3 is built up by a memory 14, a receiving unit 27 and a forwarding unit 28.

The CPU 21, which is connected to the respective hardware components such as the memory 23 etc described above via the bus, controls the hardware components such as the memory 23, and executes predetermined processes according to a control program stored in the ROM serving as the memory 23. The memory 23 includes the volatile RAM and the nonvolatile ROM. It is sufficient for the operation unit 24 to be a general type of operation button needed for operating the mobile terminal 3, and the operation unit 24 may also be of a touch display system. The interface unit 26 in the first embodiment is configured by an infrared-ray port communicable with the navigation equipment 4. The interface unit 26 is, however, sufficient if connectable electrically to the navigation equipment 4 irrespective of a wired connection and a wireless connection. The interface unit 26 may be a connector for connecting a cable and may also be a bluetooth (registered trademark)-based transmitting unit.

The memory 23 is stored with a variety of control programs necessary for the mobile terminal 3. Further, the memory 23 can be also temporarily stored with the plural pieces of position information transmitted from the server 2. The receiving unit 27 receives the spot information transmitted from the server 2. Further, the forwarding unit 28 forwards the position information (longitude/latitude) contained in the spot information received by the receiving unit 27 to the navigation equipment 4 through the infrared-ray communications. Note that the receiving unit 27 and the forwarding unit 28 can be configured as computer programs running on the CPU 21. Further, the receiving unit 27 and the forwarding unit 28 may also be configured as dedicated processors.

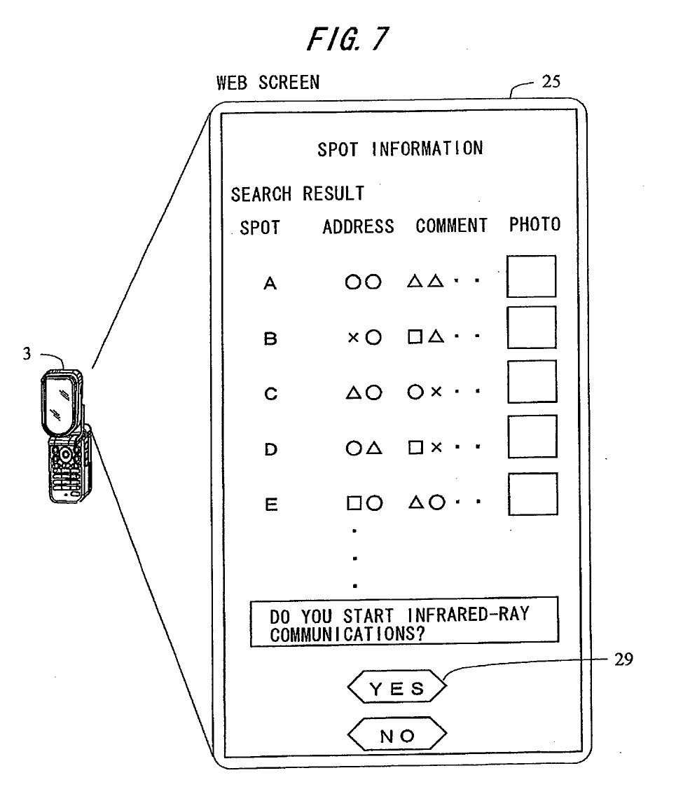

Herein, FIG. 7 shows one example of a display status of the spot information transmitted to the mobile terminal 3 from the server 2. As shown in FIG. 7, the Web page showing a result of the search is displayed on the display unit 25 of the mobile terminal 3, and a spot name, an address, a comment and a photo are displayed on this Web page. Hyperlinks are set in the respective spots, whereby the Web page can be jumped to another Web page showing more detailed information by selecting each spot. Further, in addition to the result of the search, a comment saying [Do you start the infrared-ray communications?] and a transmission button 29 for executing the transmission of the spot information as the result of the search, are displayed on the Web page illustrated in FIG. 7. The user of the mobile terminal 3 selects the predetermined spot from within the result of the search, and forwards the position information (the longitude/latitude) contained in the spot information of the desired spot to the navigation equipment 4 by pressing the transmission button 29. Note that the navigation equipment 4 is required to previously enable the infrared-ray communications to be performed in order to make the position information acceptable from the mobile terminal 3.

(Navigation Equipment)

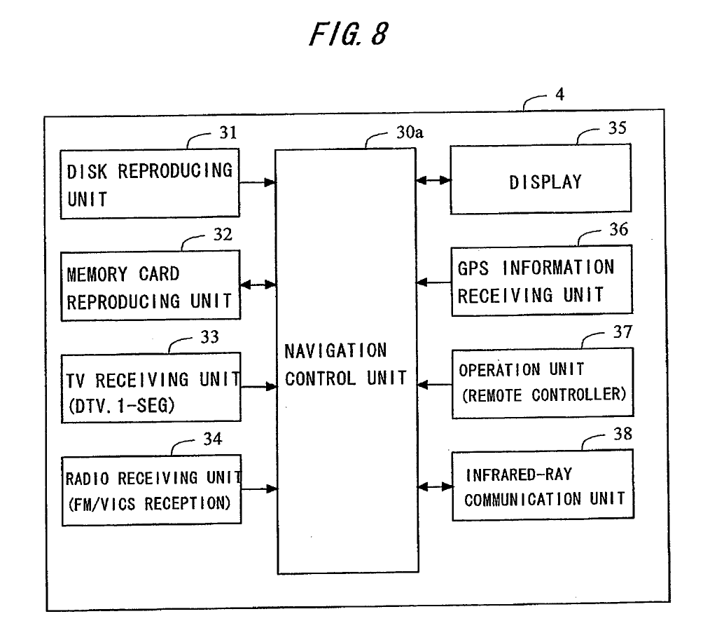

FIG. 8 shows an outline of a configuration of the navigation equipment 4. The navigation equipment 4 includes a disk reproducing unit 31, a memory card reproducing unit 32, a TV receiving unit 33, a radio receiving unit 34, a display 35, a GPS information receiving unit 36, an operation unit 37, an infrared-ray communication unit 38, and a navigation control unit 30a electrically connected to these components.

The disk reproducing unit 31 reproduces content data recorded on a CD, a DVD, etc. The disk reproducing unit 31 can be constructed of a CD/DVD deck. The memory card reproducing unit 32 reproduces the content data stored on a mobile storage medium such as a USB (Universal Serial Bus) memory and an SD (Secure Digital) memory card. The TV receiving unit 33 receives a DTV (Digital Television) broadcast and a one-segment (1 seg) broadcast. The TV receiving unit 33 can be constructed of an existing tuner. The radio receiving unit 34 receives an FM broadcast, an AM broadcast, VICS (Vehicle Information and Communication System) information, etc. The radio receiving unit 34 can be constructed of an existing tuner. The display 35 displays various items of information (e.g. the years of building, the time taken from the closest station, the room arrangement) transferred together with the position information in addition to map information and a guidance route. It is preferable that the display 35 is of a touch panel type, however, multiple existing displays can be applied to the display 35. The GPS information receiving unit 36 receives the GPS information. The GPS information receiving unit 36 receives the GPS information. The GPS information receiving unit 36 can be constructed of an existing GPS receiving antenna. The operation unit 37 transmits an electric signal corresponding to the operation button to the navigation control unit 30a. The operation unit 37 may be provided in the navigation equipment 4 and may also be a remote controller enabling remote control to be done. The infrared-ray communication unit 38 receives the infrared rays output from the mobile terminal 3.

Incidentally, the navigation equipment 4 may be a so-called portable navigation equipment demountable from the vehicle 5. In this case, the navigation equipment 4 may take a configuration having a built-in speaker and a built-in memory card in addition to the components described above. The speaker outputs a voice reproduced by the disk reproducing unit 31 and the memory card reproducing unit 32. The memory card is exemplified by the mobile storage medium such as the USB memory and the SD memory card.

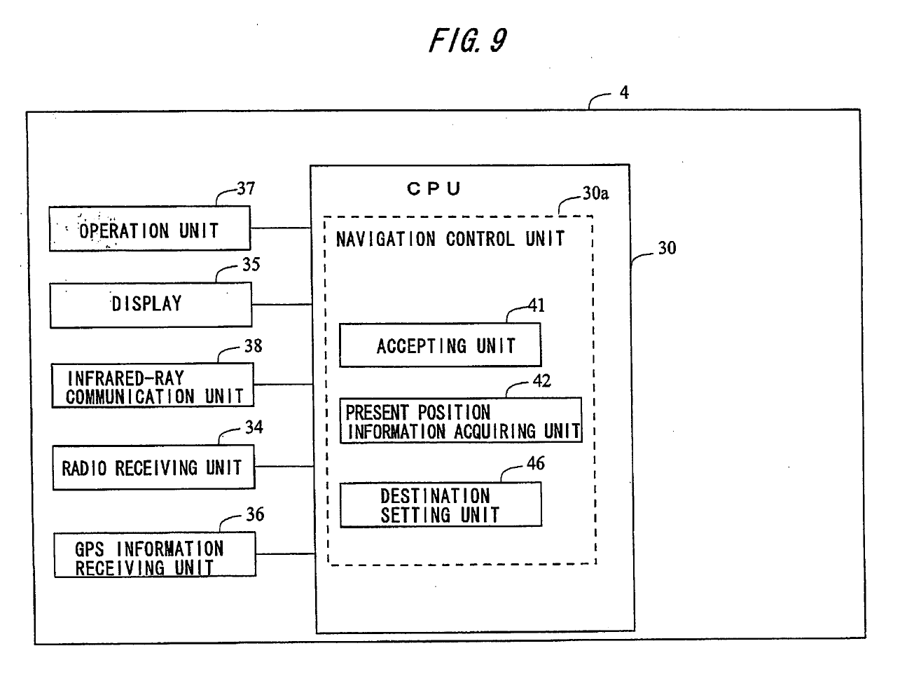

Next, the navigation control unit 30a mounted in the navigation equipment 4 will be described. FIG. 9 shows a diagram of function blocks of the navigation control unit 30a. Note that the function block diagram shown in FIG. 9 omits an illustration of a control unit for controlling the disk reproducing unit 31 and the memory card reproducing unit 32 described above.

As illustrated in FIG. 9, the navigation control unit 30a includes an accepting unit 41, a present position information acquiring unit 42, and a destination setting unit 46. It is to be noted that the navigation control unit 30a can be realized by a computer including a CPU, a memory, etc and by a program running on the computer.

The accepting unit 41 accepts the position information (the longitude/latitude) contained in the predetermined spot information through the infrared-rays from the mobile terminal 3, which are received by the infrared-ray communication unit 38. Note that the accepting unit 41 can also accept information other than the position information. The present position information acquiring unit 42 acquires the present position information related to the present position of the navigation equipment 4 from the GPS information receiving unit 36. The destination setting unit 46 sets a destination based on the position information contained in the predetermined spot information accepted by the receiving unit 41.

<Processing Flow>

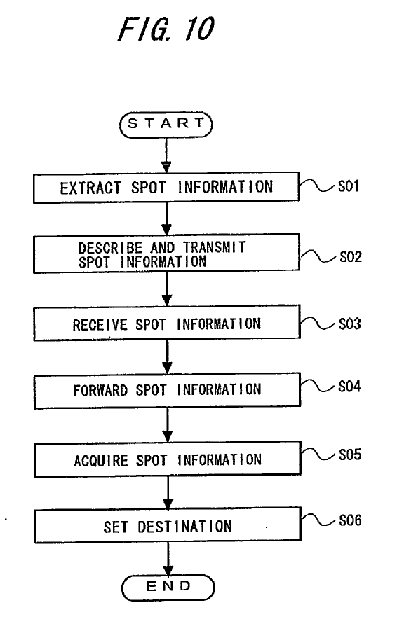

Next, a flow of a destination setting process executed by the destination setting system 1 according to the first embodiment will be described. FIG. 10 shows the flow of the destination setting process carried out by the destination setting system 1.

A start of the destination setting processing flow is triggered by such an event that the user of the mobile terminal 3 inputs the search conditions from on the mobile terminal 3. When the search conditions are inputted from on the mobile terminal 3, the extraction unit 17 of the server 2 connected via the communication network 6 to the mobile terminal 3 extracts the predetermined spot information matching with the search conditions from the spot information (see FIG. 4) stored in the storage unit 15 (step S01). The operation proceeds to step S02 when completing the extraction of the predetermined spot information.

In step S02, the extracted piece of predetermined spot information is described in the HTML format and thus transmitted to the mobile terminal 3. The predetermined spot information contains, in addition to the longitude/latitude, the address, the URL, etc. on the spot-by-spot basis. Upon completing the transmission of the extracted spot information, the operation proceeds to step S03.

In step S03, the receiving unit 27 of the mobile terminal 3 receives the predetermined spot information transmitted from the server 2. Namely, the Web page (see FIG. 7) is displayed on the display unit 25 of the mobile terminal 3. Next, in step S04, the transmission button 29 provided on the Web page is pressed, whereby one piece of spot information selected by the user from within the predetermined spot information displayed on the Web page is forwarded to the navigation equipment 4 through the infrared-ray communications. When completing the forwarding of the position information to the navigation equipment 4, the operation proceeds to step S05.

In step S05, the accepting unit 41 of the navigation equipment 4 acquires the predetermined spot information. Next in step S06, a destination is set based on the position information (longitude/latitude) contained in the predetermined spot information acquired by the accepting unit 41.

<Effect>

According to the navigation system 1 in the first embodiment discussed above, the destination of the navigation equipment can be set based on the spot information generated based on the write information from the plurality of users, i.e., the spot information in which an extremely large quantity of new information reflects. As a result, according to the present invention, the user can be guided to the destination that is as close as the user desires.

### Second Embodiment

Next, the navigation system 1 according to a second embodiment will be described. The following discussion will be focused on differences from the navigation system 1 in the first embodiment.

<Architecture>

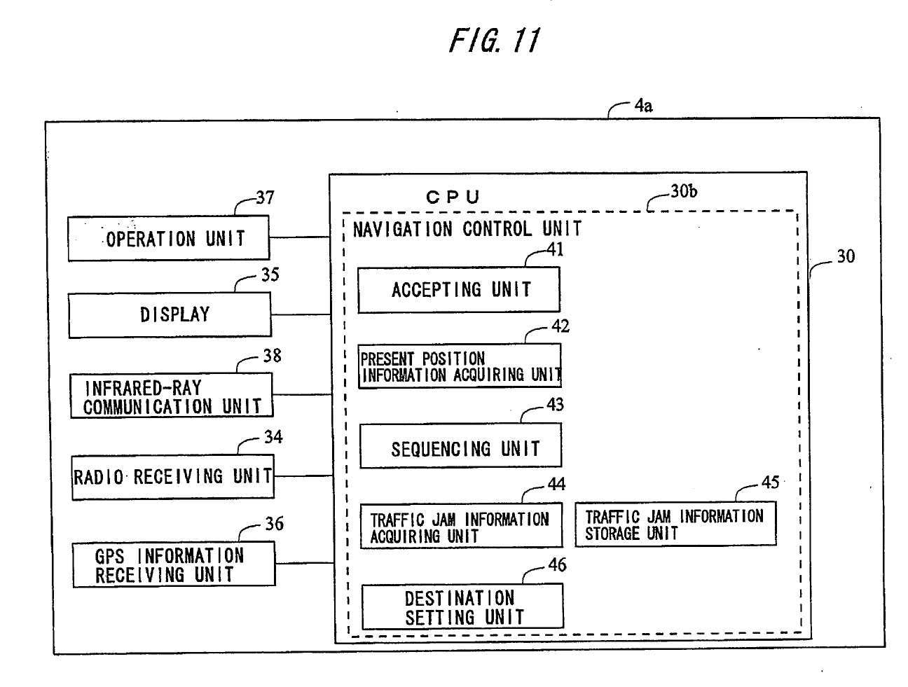

The navigation system 1 in the second embodiment is different in terms of only a configuration of the navigation control unit 30b of the navigation equipment 4a from the navigation system 1 in the first embodiment. FIG. 11 shows a function block diagram of the navigation control unit 30b of the navigation equipment 4a in the second embodiment. As illustrated in FIG. 11, the navigation control unit 30b in the second embodiment is provided with, in addition to the configuration (components) of the navigation control unit 30a in the first embodiment, a sequencing unit 43, a traffic jam information acquiring unit 44 and a traffic jam information storage unit 45.

The sequencing unit 43 compares the present position information acquired by the present position information acquiring unit 42 with the position information (longitudes and latitudes of a spot A through a spot E), sequences the pieces of position information on the basis of predetermined conditions including at least any one of a distance from the present position to a destination and a period of time required from the present position to the destination.

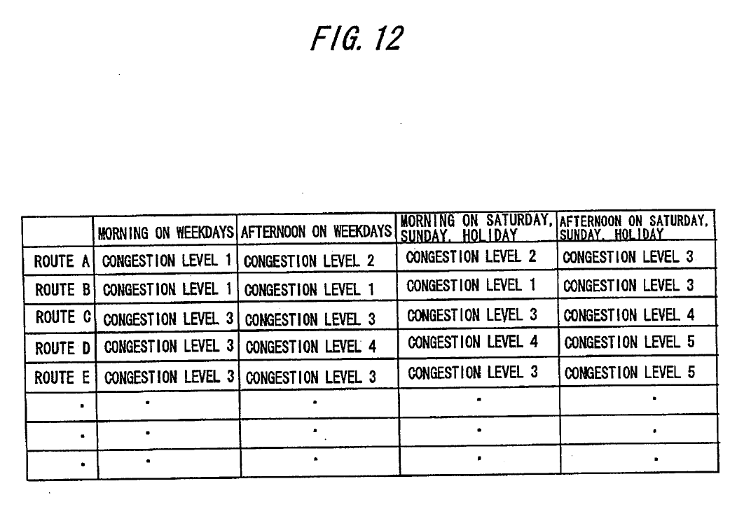

The traffic jam information acquiring unit 44 acquires traffic jam information. To be specific, the traffic jam information acquiring unit 44 acquires the VICS information received by a radio receiving unit 34. The traffic jam information storage unit 45 is stored with the traffic jam information acquired by the traffic jam information acquiring unit 44. Herein, FIG. 12 shows one example of a traffic jam information database. The database shown in FIG. 12 is structured such that a crowded state per guide route (Route) is expressed stepwise. Further, the crowded states are sorted according to time zones and days of the week. Incidentally, as to a congestion level, a congestion level 5 represents the most crowded state. The thus-acquired traffic jam information is databased and taken into consideration when sequencing the position information, thereby enabling the position information to be sequenced more properly without being influenced by an error caused by a time lag etc when receiving the VICS information.

Note that the traffic jam information acquiring unit 44 includes the volatile RAM and the nonvolatile ROM. Further, in the navigation control unit 30b, each of the receiving unit 41, the present position information acquiring unit 42, the sequencing unit 43 and the traffic jam information acquiring unit 44 can be configured as a computer program running on a CPU 30. Moreover, these components may also be configured as dedicated processors.

<Processing Flow>

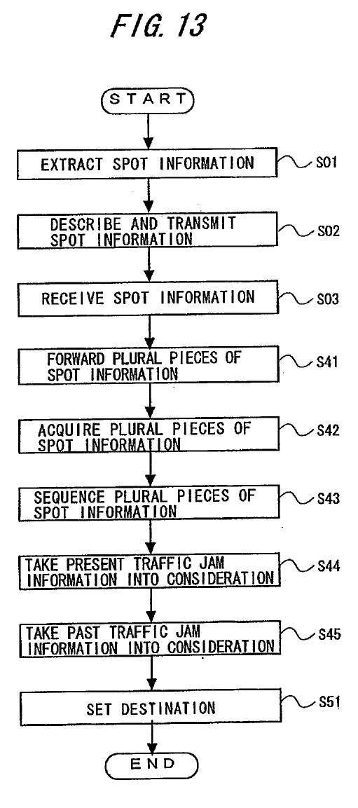

Next, a flow of a destination setting process executed by the destination setting system 1 according to the second embodiment will be described. FIG. 13 shows the flow of the destination setting process carried out by the destination setting system 1. In the flow of the destination setting process according to the second embodiment, in the same way as in the flow of the destination setting process according to the first embodiment discussed above, the processes in step S01 through step S03 are executed. Such being the case, the following discussion will deal with processes after finishing the process in step S03.

In step S41, the transmission button 29 provided on the Web page displayed on the display unit 25 of the mobile terminal 3 is pressed, whereby plural pieces of predetermined spot information displayed on the Web page are forwarded to the navigation equipment 4a through the infrared-ray communications. Namely, in the flow of the destination setting process according to the first embodiment, one piece of predetermined spot information selected by the user is forwarded, however, according to the second embodiment, the plural pieces of predetermined spot information are forwarded. Note that all pieces of predetermined spot information displayed on the Web page may also be forwarded, then the predetermined spot information may be set selectable by the user, and the plural pieces of selected predetermined spot information may also be forwarded.

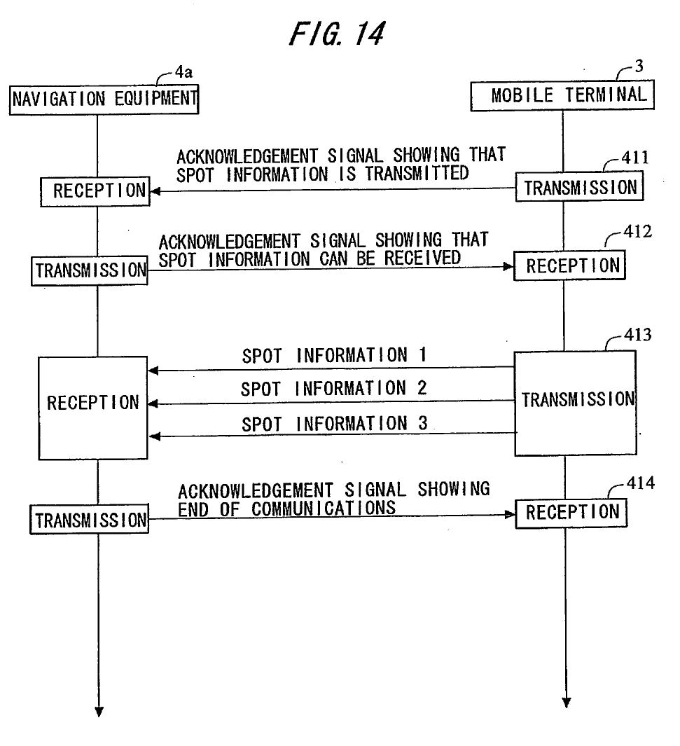

Herein, FIG. 14 shows a sequence diagram in the case of forwarding the plural pieces of predetermined spot information at one time. To begin with, in step S411, an acknowledgement signal for transmitting the spot information is transmitted to the navigation equipment 4a from the mobile terminal 3. Subsequently, in step S412, the acknowledgement signal, representing that the spot information can be received, is transmitted to the mobile terminal 3 from the navigation equipment 4a. In step S413 subsequent thereto, the plural pieces of predetermined spot information (spot information 1, spot information 2, spot information 3) to the navigation equipment 4a from the mobile terminal 3. Thereafter, in step S414, the navigation equipment 4a transmits an acknowledgement signal representing an end of the communications to the mobile terminal 3. The forwarding of the plural pieces of spot information is completed by what has been done so far. Incidentally, in the case of forwarding one piece of spot information, basically the spot information is forwarded in the same sequence. Upon the completion of forwarding the plural pieces of predetermined spot information to the navigation equipment 4a, the operation proceeds to step S42.

In step S42, the accepting unit 41 of the navigation equipment 4a acquires the plural pieces of predetermined spot information. Next in step S43, the present position information acquired by the present position information acquiring unit 42 is compared with the position information contained in the plural pieces of predetermined spot information accepted by the accepting unit 41, and the pieces of spot information are sequenced based on the predetermined conditions. More specifically, the sequencing unit 43 compares the present position information (the longitude/latitude) received by the GPS information receiving unit 36 with the position information (the longitude/latitude) contained in the plural pieces of predetermined spot information acquired by the accepting unit 41; and sequences the position information in the order from the shortest distance. For example, if a distance from the present position to the spot B is the shortest distance, the spot B is set as a first destination.

Note that the present position information is acquired as the process separately from the processes in steps S42, S43, and this acquiring process is repeated at predetermined intervals. Namely, the present position information is acquired any time by the present position information acquiring unit 42. The sequencing unit 43 compares the present position information thus acquired at the predetermined intervals with the position information contained in the plural pieces of predetermined spot information acquired by the accepting unit 41, thus sequencing the position information.

Next in step S44, the present (real-time) traffic jam information is taken into consideration with respect to the predetermined spot information sequenced in step S43. Namely, the sequencing unit 43 takes into consideration the present traffic jam information acquired by the traffic jam information acquiring unit 44, and again sequences the position information as the necessity may arise. To be specific, the sequencing unit 43, when taking the present traffic jam information into consideration and if the sequencing of the predetermined spot information which is executed in step S43 is determined to be improper, re-executes the sequencing process taking account of the traffic jam information. Upon completion of the sequencing process taking the present traffic jam information into consideration, the operation proceeds to step S45.

In step S45, the past traffic jam information stored in the traffic jam information storage unit 45 is taken into consideration. Namely, the sequencing unit 43 further takes account of the past traffic jam information with the respect to the sequencing process taking the present traffic jam information into consideration, and again sequences the position information according to the necessity. For example, in step S43, the pieces of position information are sequenced by setting the spot B as the first destination, a route E as the guide route leading to the spot B is selected according to the present traffic jam information even if not congested in particular, and, when the present time zone is the afternoon on Saturday or Sunday or Holiday (see FIG. 12), the sequencing process is again conducted in a way that takes account of the congestion level. As a result, for instance, the sequencing such as the spot C, the spot B, the spot A, the spot D and the spot E is carried out. Thus, the past traffic jam information is considered as well as the present traffic jam information, thereby enabling the more proper sequencing process to be performed without being influenced by the error caused by the time lag etc. When completing the sequencing process taking the past traffic jam information into consideration, the operation proceeds to step S51.

Note that the traffic jam information is acquired as the process separately from the processes in steps S42 through S44, and this acquiring process is repeated at predetermined intervals. Namely, the traffic jam information acquiring unit 44 acquires the traffic jam information by obtaining the VICS information at intervals of, e.g., 5 min. Further, in the second embodiment, the acquired traffic jam information is stored any time in the traffic jam information storage unit 45 (see FIG. 12). Accordingly, the process of storing the traffic jam information in the traffic jam information storage unit 45, i.e., the process of generating the database exemplified in FIG. 12, may also be executed separately from the processes in steps S42 through S44.

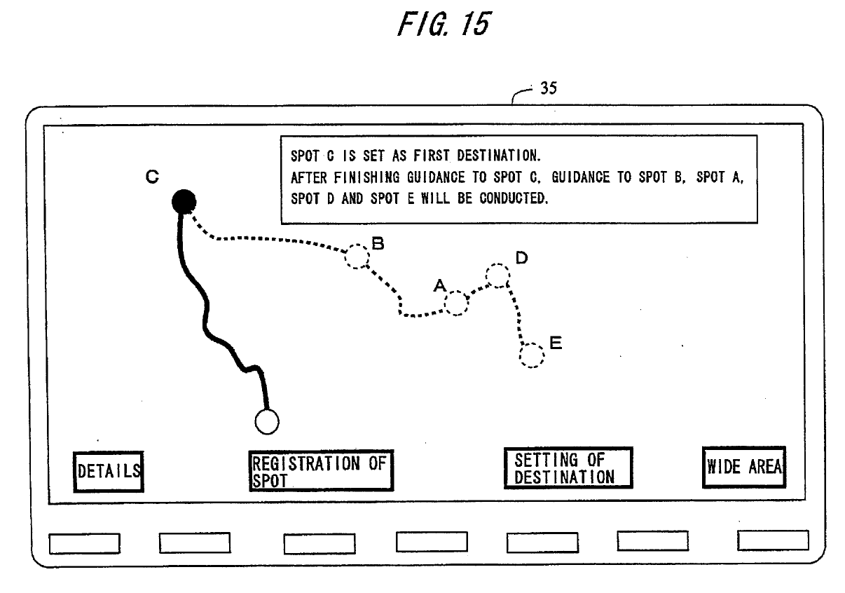

In step S51, the destination is set based on the position information contained in the predetermined spot information undergoing the execution of the sequencing process. For example, in step S45, in the case of carrying out the sequencing such as the spot C, the spot B, the spot A, the spot D and the spot E, the destination setting unit 46 sets a property C as the first destination, and the route guidance is started. When the route guidance to the property C is completed, it follows that a route guidance to a property B set as the next destination is started. Note that FIG. 15 illustrates a display status of a display 35 of the navigation equipment 4a. The display 35 displays a route to the spot C set as a first destination from the present position and other spots (the spot B, the spot A, the spot D and the spot E).

<Effects>

The navigation system 1 according to the second embodiment discussed above can, in addition to the effects of the navigation system 1 in the first embodiment, simultaneously accept the position information contained in the plural pieces of spot information from the mobile terminals and can therefore obviate such a time-consuming process that the destination is set each time. Moreover, the navigation system 1 according to the second embodiment sets the destination after sequencing the position information based on the distance from the present position to the destination, and can therefore reduce the operation load of the user without its being necessary for the user himself or herself to sequence the position information.

### Third Embodiment

Next, the navigation system 1 in a third embodiment will be explained. The following discussion will be focused on differences from the navigation system 1 in the first embodiment.

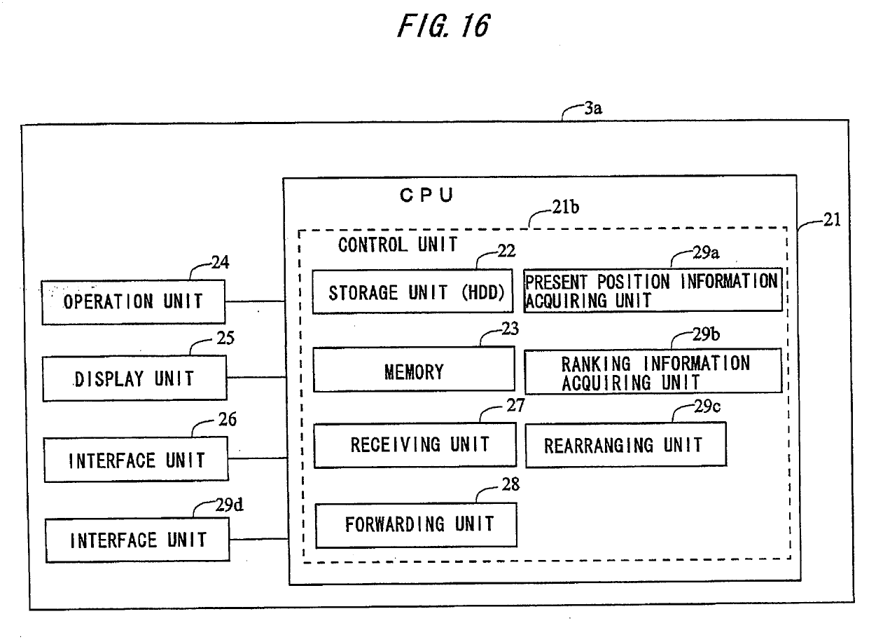

The navigation system 1 in the third embodiment is different in terms of only a configuration of the control unit 21b of a mobile terminal 3a from the configuration of the mobile terminal 3 in the navigation system 1 in the first embodiment. FIG. 16 shows a function block diagram of the control unit 21b of the mobile terminal 3a in the third embodiment. As shown in FIG. 16, the mobile terminal 3a in the third embodiment has a GPS information receiving unit 29d, and the control unit 21b in the third embodiment is further provided with, in addition to the configuration (components) of the control unit 21a in the first embodiment, a present position information acquiring unit 29a, a ranking information acquiring unit 29b and a rearranging unit 29c.

The present position information acquiring unit 29a acquires the present position information from the GPS information receiving unit 29d provided in the mobile terminal 3a. The ranking information acquiring unit 29b acquires various categories of ranking information about the spot information. The rearranging unit 29c compares the present position information acquired by the present position information acquiring unit 29a with the position information contained in the plural pieces of predetermined spot information received by a receiving unit 27, and sequences the pieces of position information on the basis of predetermined conditions including at least any one of a distance from the present position to a destination and a period of time required from the present position to the destination. Further, the rearranging unit 29c rearranges, based on the ranking information, the plural pieces of predetermined spot information received by the receiving unit 27. The forwarding unit 28 forwards the plural pieces of rearranged predetermined spot information to the navigation equipment 4 through the infrared-ray communications. It is to be noted that the ranking information acquiring unit 29b and the rearranging unit 29c can be configured as computer programs running on the CPU 21. Moreover, the ranking information acquiring unit 29b and the rearranging unit 290 may be built up as dedicated processors.

Note that when the forwarding unit 28 forwards the plural pieces of rearranged predetermined spot information to the navigation equipment 4 through the infrared-ray communications, the navigation equipment 4 sets the destination based on the position information contained in the plural pieces of rearranged predetermined spot information. The operation performed so far, according to the navigation system 1 in the third embodiment, enables the mobile terminal to rearrange the spot information.

What is claimed is:

1. A navigation system setting a destination of navigation equipment by forwarding spot information containing at least position information managed by a server to the navigation equipment via a mobile terminal, said server comprising:
write information accepting unit that accepts write information from a plurality of users via a network;
spot information generating unit that generates the spot information based on the write information accepted by said write information accepting unit;
storage unit stored with the spot information generated by said spot information generating unit;
extracting unit that extracts, from the spot information stored in said storage unit, predetermined spot information corresponding to candidates of the destination in response to a search request given from said mobile terminal; and
transmitting unit that transmits the predetermined spot information extracted by said extracting unit to said mobile terminal,
said mobile terminal comprising:
receiving unit that receives the predetermined spot information transmitted by said transmitting unit;
terminal display unit that displays the predetermined spot information received by said receiving unit; and
forwarding unit that forwards the predetermined spot information displayed by said terminal display unit to said navigation equipment,
said navigation equipment comprising:
accepting unit that accepts the predetermined spot information forwarded from said mobile terminal;
destination setting unit that sets the destination based on the position information contained in the predetermined spot information accepted by said accepting unit; and
navigation display unit that displays a route to the destination set by said destination setting unit.

2. A navigation system according to claim 1, wherein said accepting unit accepts plural pieces of predetermined spot information through one forwarding operation from said forwarding unit,
said navigation equipment further comprises:
present position information acquiring unit that acquires present position information about the present position of said navigation equipment: and
sequencing unit that compares the present position information acquired by said present position information acquiring unit with the position information contained in the plural pieces of predetermined spot information accepted by said accepting unit, and sequencing the plural pieces of predetermined spot information on the basis of predetermined conditions containing at least a distance from the present position to the destination and a period of time required from the present position to the destination, and
said destination setting unit sets the destination on the basis of the position information contained in the plural pieces of predetermined spot information sequenced by said sequencing unit.

3. A navigation system according to claim 1, wherein said navigation display unit displays, in addition to the route up to the destination set by said destination setting unit, spot information accepted by said accepting unit.

4. A navigation system according to claim 1, wherein said receiving unit of said mobile terminal receives the plural pieces of predetermined spot information,
said mobile terminal further comprises rearranging unit that rearranges the plural pieces of predetermined spot information under predetermined conditions,
said forwarding unit of said mobile terminal forwards the plural pieces of predetermined spot information rearranged by said rearranging unit to said navigation equipment,
said accepting unit of said navigation equipment accepts the plural pieces of rearranged predetermined spot information forwarded from said mobile terminal, and
said destination setting unit sets the destination based on the position information contained in the plural pieces of rearranged predetermined spot information accepted by said accepting unit.

5. Navigation equipment searching for a route up to a destination, comprising:
accepting unit that accepts predetermined spot information forwarded from a mobile terminal;
destination setting unit that sets a destination based on position information contained in the spot information accepted by said accepting unit; and
navigation display unit that displays the route to the destination set by said destination setting unit,
wherein the predetermined spot information is the spot information managed by a server and is the spot information corresponding to candidates of the destination extracted in response to a search request sent from said mobile terminal from within the spot information generated based on write information given from a plurality of users which is accepted via a network.

6. Navigation equipment according to claim 5, wherein said accepting unit accepts plural pieces of predetermined spot information through one forwarding operation from said forwarding unit,
said navigation equipment further comprises:
present position information acquiring unit that acquires present position information about the present position of said navigation equipment; and
sequencing unit that compares the present position information acquired by said present position information acquiring unit with the position information contained in the plural pieces of predetermined spot information accepted by said accepting unit, and sequencing the plural pieces of predetermined spot information on the basis of predetermined conditions containing at least any one of a distance from the present position to the destination and a period of time required from the present position to the destination, and
said destination setting unit sets the destination on the basis of the position information contained in the plural pieces of predetermined spot information sequenced by said sequencing unit.

7. Navigation equipment according to claim 5, wherein said navigation display unit displays, in addition to the route up to the destination set by said destination setting unit, spot information accepted by said accepting unit.

8. A destination setting method setting a destination of navigation equipment by forwarding spot information containing at least position information managed by a server to the navigation equipment via a mobile terminal, said server executing:
a write information accepting step of accepting write information from a plurality of users via a network;
a spot information generating step of generating the spot information based on the write information accepted in said write information accepting step;
a storing step of storing the spot information generated in said spot information generating step;
an extracting step of extracting, from the spot information stored in said storing step, predetermined spot information corresponding to candidates of the destination in response to a search request given from said mobile terminal; and
a transmitting step of transmitting the predetermined spot information extracted in said extracting step to said mobile terminal,
said mobile terminal executing:
a receiving step of receiving the predetermined spot information transmitted in said transmitting step;
a terminal display step of displaying the predetermined spot information received in said receiving step; and
a forwarding unit forwarding the predetermined spot information displayed in said terminal display step to said navigation equipment,
said navigation equipment executing:
an accepting step of accepting the predetermined spot information forwarded from said mobile terminal;
a destination setting step of setting the destination based on the position information contained in the predetermined spot information accepted in said accepting step; and
a navigation display step of displaying a route to the destination set in said destination setting step.

9. A destination setting method according to claim 8, wherein said accepting step includes accepting plural pieces of predetermined spot information through one forwarding operation in said forwarding step,
said navigation equipment further executing:
a present position information acquiring step of acquiring present position information about the present position of said navigation equipment; and
a sequencing step of comparing the present position information acquired in said present position information acquiring step with the position information contained in the plural pieces of predetermined spot information accepted in said accepting step, and sequencing the plural pieces of predetermined spot information on the basis of predetermined conditions containing at least a distance from the present position to the destination and a period of time required from the present position to the destination, and
said destination setting step includes setting the destination on the basis of the position information contained in the plural pieces of predetermined spot information sequenced in said sequencing step.

10. A destination setting method according to claim 8, wherein said navigation display step includes displaying, in addition to the route up to the destination set in said destination setting step, spot information accepted in said accepting step.
